(19) United States
(12) Patent Application Publication
(10) Pub. No.: US 2026/0126626 A1
(43) Pub. Date: May 7, 2026

(54) SYSTEM, IMAGING DEVICE INCLUDING SYSTEM, AND LENS DEVICE INCLUDING SYSTEM

(71) Applicant: CANON KABUSHIKI KAISHA, Tokyo (JP)

(72) Inventor: MAYU OHHORI, Tochigi (JP)

(21) Appl. No.: 19/360,742

(22) Filed: Oct. 16, 2025

(30) Foreign Application Priority Data
Nov. 7, 2024 (JP) 2024-195050

(51) Int. Cl. G02B 13/00

(52) U.S. Cl. CPC G02B 13/0045

(57) ABSTRACT

A system includes, in order from an object side to an image side, a front unit having negative refractive power, an aperture stop, a rear unit having positive refractive power, and at least ten lenses. The rear unit includes an aspherical lens having an inflection point, and, when the focal length of the system as a whole is denoted by f, the focal length of the front unit is denoted by f1, the maximum image height of the system is denoted by ImgH, and the overall length of the system is denoted by L, the system satisfies a predetermined inequality.

### BACKGROUND

### Field of the Technology

The aspect of the embodiments relates to a system suitable for a digital still camera, a digital video camera, a monitoring camera, an onboard camera, a smartphone camera, and the like, an imaging device including a system, and a lens device including a system.

### Description of the Related Art

In a wide-angle optical system, distortion aberration generated in the optical system can be corrected by disposing a lens unit on the object side with respect to an aperture. Japanese Patent Laid-Open No. 2023-184065 discloses a wide-angle optical system in which a front lens unit having negative refractive power, an aperture stop, and a rear lens unit having positive refractive power are disposed in order from the object side.

### SUMMARY

A system including, in order from an object side to an image side, a front unit having negative refractive power, an aperture stop, a rear unit having positive refractive power, and at least ten lenses, wherein the rear unit includes an aspherical lens having an inflection point, and the following inequalities are satisfied:

$$- 2.98 < f 1 / f < 0 \text{.00}$$

$$0. 40 < ImgH / L$$

where f denotes a focal length of the system as a whole, f1 denotes a focal length of the front unit, ImgH denotes a maximum image height of the system, and L denotes an overall length of the system.

Features of the disclosure will become apparent from the following description of embodiments with reference to the attached drawings. The following description of embodiments is described by way of example.

### BRIEF DESCRIPTION OF THE DRAWINGS

FIG. 1 is a sectional view of an optical system of Example 1 during infinity focus.

FIG. 2 is a longitudinal aberration diagram corresponding to Example 1.

FIG. 3 is a sectional view of an optical system of Example 2 during infinity focus.

FIG. 4 is a longitudinal aberration diagram corresponding to Example 2.

FIG. 5 is a sectional view of an optical system of Example 3 during infinity focus.

FIG. 6 is a longitudinal aberration diagram corresponding to Example 3.

FIG. 7 is a sectional view of an optical system of Example 4 during infinity focus.

FIG. 8 is a longitudinal aberration diagram corresponding to Example 4.

FIG. 9 is a schematic view relating to a hit point of an off-axis ray on an optical surface.

FIG. 10 is a schematic view of an imaging device in which the optical system of one of Examples 1 to 4 is used.

FIG. 11 is a schematic view of a lens device in which the optical system of one of Examples 1 to 4 is used.

### DESCRIPTION OF THE EMBODIMENTS

Hereinafter, an embodiment disclosed in the specification will be described in detail with reference to the drawings. In the drawings, identical members are given identical reference numbers, and duplicated description thereof will be omitted.

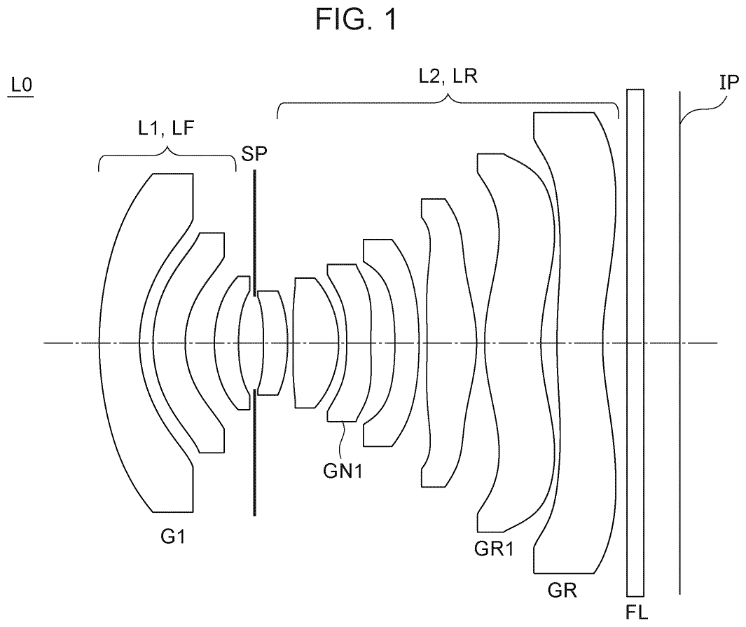

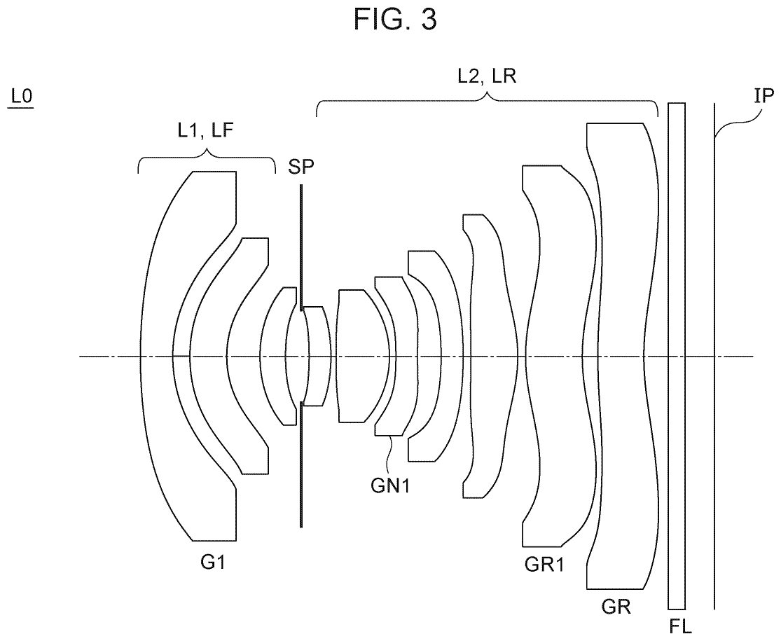

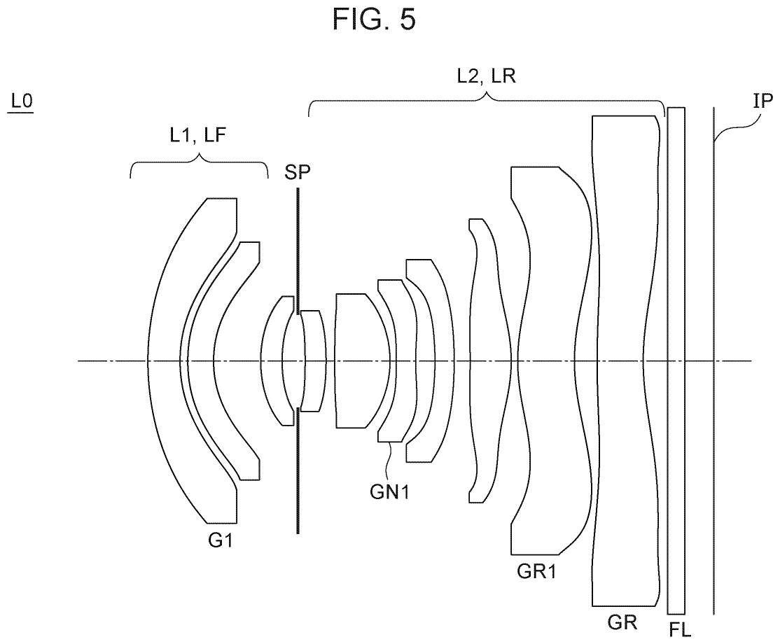

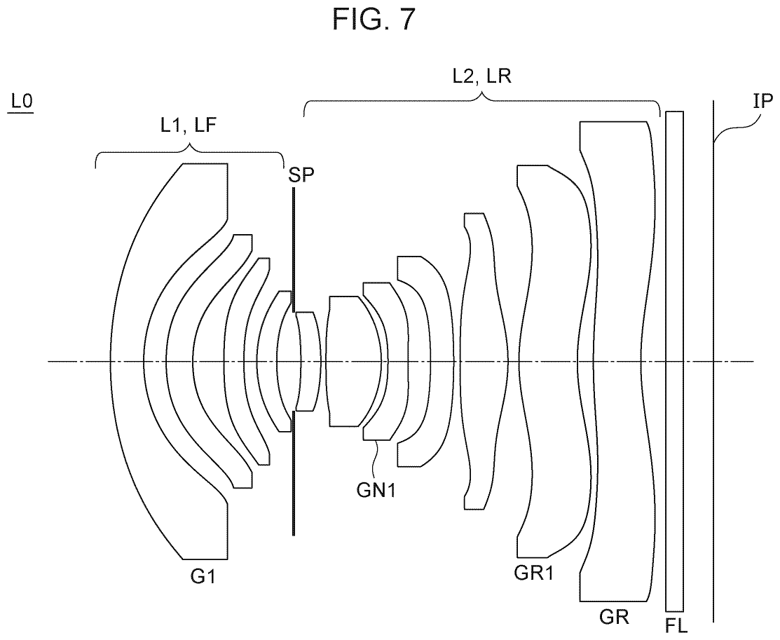

FIGS. 1, 3, 5, and 7 are sectional views of optical systems L0 of Examples 1 to 4, respectively, during infinity focus. The optical system L0 of each of the examples is to be used in an imaging device, such as a digital still camera, a digital video camera, a monitoring camera, or an onboard camera.

In each of the sectional views, the left side is the object side, and the right side is the image side. The optical system L0 of each of the examples includes a plurality of lens units. Note that a lens unit in the specification refers to a group of lenses that are isolated from each other by an aperture stop SP. In addition, each lens unit may consist of one lens or may consist of a plurality of lenses. In addition, each lens unit may include an aspherical lens, a Fresnel lens, a meta-lens, a diffractive optical element, and the like.

In the optical system L0 of each of the examples, Li denotes, among the lens units included in the optical system L0, an i-th (i is a natural number) lens unit counted from the object side. In addition, Gk denotes, among the lenses included in the optical system, a k-th (k is a natural number) lens counted from the object side.

In the optical system L0 of each of the examples, L1 (LF) denotes a front unit as a lens unit disposed on the object side with respect to the aperture stop. In addition, L2 (LR) denotes a rear unit as a lens unit disposed on the image side with respect to the aperture stop.

In each of the sectional views, SP is the aperture stop. In addition, FL is an optical element corresponding to an optical filter, a low-pass filter, an infrared cut filter, or the like. IP is an image plane, and, when the optical system L0 of each of the examples is used as an imaging optical system of a digital still camera or a digital video camera, an imaging surface of a solid-state image sensing device, such as a CCD sensor or a CMOS sensor, is arranged on the image plane IP. When the optical system L0 of each of the examples is used as an imaging optical system of a silver-halide film camera, the image plane IP serves as a photosensitive surface corresponding to a film surface. Note that the optical system in each of the examples may be used as a projection lens of a projector or the like. In this case, the left side is the screen side, and the right side is the projected image side.

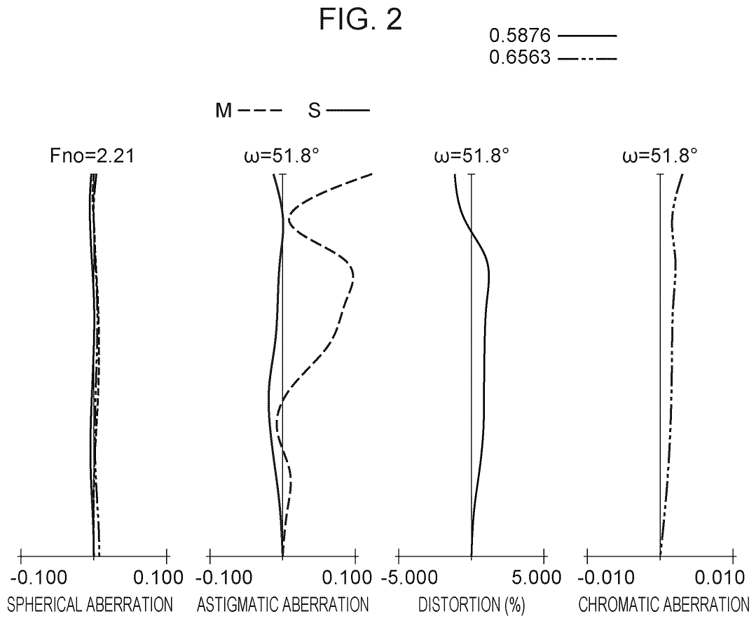

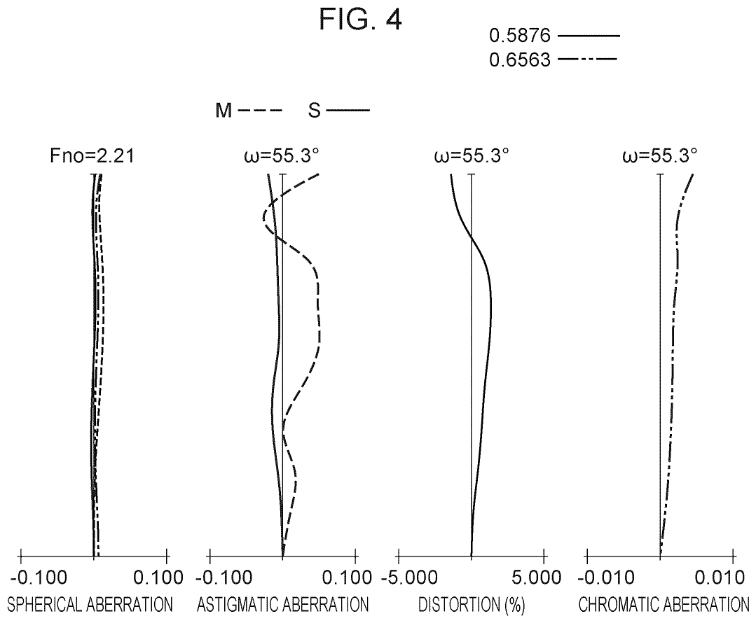

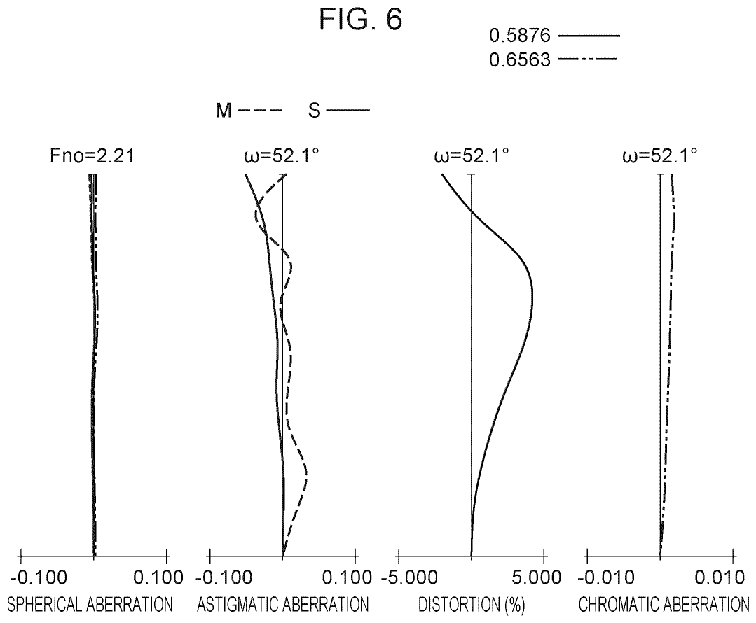

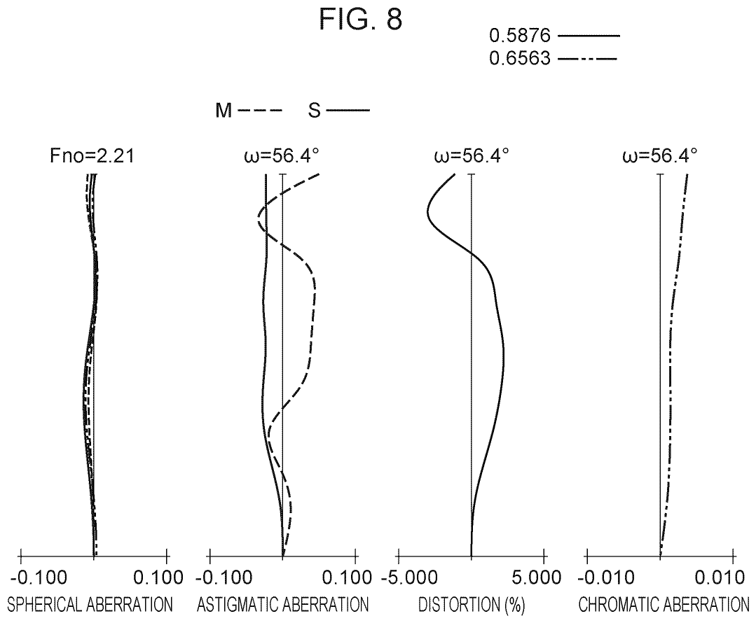

FIGS. 2, 4, 6, and 8 are aberration diagrams of the optical systems L0 of Examples 1 to 4, respectively, during infinity focus. In each of the diagrams, spherical aberration, astigmatic aberration, distortion aberration, and magnification chromatic aberration are indicated in order from the left. In the spherical aberration diagram, Fno. is F-number, the solid line indicates the d-line (wavelength 587.6 nm), and the two-dot-dash line indicates the amount of spherical aberration with respect to the g-line (wavelength 435.8 nm). In the astigmatic aberration diagram, the solid line indicates a sagittal image plane, and the dashed line indicates the field curvature amount of a meridional image plane. In the distortion aberration diagram, the amount of distortion aberration with respect to the d-line is indicated. In the magnification chromatic aberration diagram, chromatic aberration at the g-line is illustrated. In addition, w is a half angle of view [°].

Here, an off-axis focal length used in each of the examples will be described. When the maximum half angle of view of the optical system L0 in which the on-axis focal length is f0 is ω [°], the off-axis focal length is a focal length for an off-axis ray when the off-axis ray that has entered at the angle ω [°] with respect to an optical axis passes through the center of the aperture stop SP and forms an image on the image side.

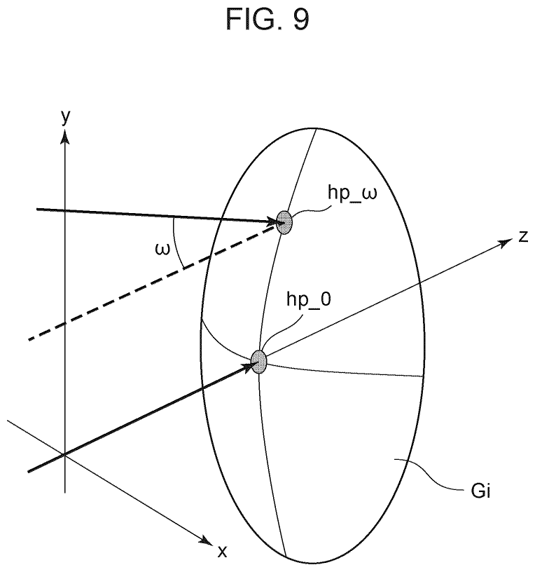

FIG. 9 illustrates a method of calculating the off-axis focal length. In FIG. 9, Gi is an optical surface such as a lens surface, an optical axis direction at the optical surface is the Z-direction, and, among directions orthogonal to the Z-direction, two directions orthogonal to each other are the X-direction and the Y-direction. When the Z-direction is parallel to the horizontal direction, the X-direction is also parallel to the horizontal direction, and the Y-direction is parallel to the vertical direction.

In FIG. 9, an intersection point at which an on-axis ray intersects the optical surface Gi is hp_0. In addition, an intersection point at which an off-axis ray that enters at the maximum angle of view ω [°] intersects the optical surface Gi is a hit point hp_ω. When the curvature near an off-axis principal ray at the hit point hp_ω is calculated, the curvature is different depending on an azimuth angle. As described in the following Reference Literature 1, the focal length for an off-axis principal ray can be obtained by calculating the curvature at the hit point.
(Reference Literature 1) Keisuke ARAKI, “Extension of Non-Co-Axial Optics into the Imaging Systems” Japanese journal of optics, the Optical Society of Japan, June 2008, vol. 37, No. 6, p. 334-339

Next, characteristic components of the optical system L0 of each of the examples will be described.

The optical system L0 of each of the examples includes in order from the object side, the front unit L1 having negative refractive power, the aperture stop SP, and the rear unit L2. With the front unit L1 having the negative refractive power, the optical system L0 has a configuration of a so-called retrofocus type, and the principal point is thus arranged on the image side and makes it possible to ensure back focus. In addition, it is possible to downsize the optical system L0 in the radial direction.

The optical system L0 of each of the examples includes an aspherical lens (lens A). In addition, in the optical system L0 of each of the examples, a lens surface of an aspherical lens included in the rear unit L2 has an inflection point. The inflection point on the lens surface is a point at which the sign of the refractive power of the lens changes from a portion of the lens surface near the optical axis toward a peripheral portion of the lens surface. Including the aspherical lens having an inflection point makes it possible to favorably correct curvature of field and astigmatic aberration.

Note that, one example of the aspherical lens having an inflection point is an aspherical lens that has a lens shape such that the object-side lens surface of the aspherical lens includes a portion that is near the optical axis and convex on the object side and a peripheral portion that is concave on the object side. Similarly, the image-side lens surface of the aspherical lens includes a portion that is near the optical axis and concave on the image side and a peripheral portion that is convex on the image side. Consequently, it is possible to correct astigmatic aberration at the peripheral portion while correcting the Petzval sum at the portion near the optical axis of the aspherical lens. Note that the object-side lens surface of the aspherical lens is not limited thereto and may include a portion that is near the optical axis and concave on the object side and a peripheral portion that is convex on the object side. Similarly, the image-side lens surface of the aspherical lens may include a portion that is near the optical axis and concave on the image side and a peripheral portion that is convex on the image side.

In addition, the optical system L0 of each of the examples is characterized by satisfying the following inequality (1), where f denotes the focal length of the optical system L0 as a whole.

$$- 2.98 < f 1 / f < 0.00 \qquad ( 1 )$$

The inequality (1) defines the focal length of the front unit L1 with respect to the focal length of the optical system L0 as a whole. By satisfying the inequality (1), it is possible to improve the formability of lenses constituting the front unit L1 while favorably correcting various aberrations. When the focal length of the front unit L1 is less than a lower limit of the inequality (1), the absolute value of the negative refractive power of the front unit L1 decreases. At this time, to achieve both the correction of distortion aberration and correction of field curvature, the thickness deviation ratio of each of the lenses that constitute the front unit L1 is to be increased, which is not preferable since the formability of the lenses decreases. When the focal length of the front unit L1 is more than an upper limit of the inequality (1), correction of the distortion aberration and the field curvature is difficult, which is not preferable, since the front unit L1 has positive refractive power.

In addition, in one embodiment, the numerical ranges in the inequality (1) are set to be the ranges in the following inequality (1a).

$$- 2.80 < f 1 / f < 1. \qquad ( 1 a )$$

In addition, in another embodiment, the numerical ranges in the inequality (1) are set to be the ranges in the following inequality (1b).

$$- 2.75 < f 1 / f < - 2. \qquad ( 1 b )$$

Next, conditions that are for the optical system L0 of each of the examples to satisfy will be described.

When the maximum image height of the optical system L0 is denoted by ImgH and the optical overall length thereof is denoted by L, in one embodiment, the following inequality (2) is satisfied.

$$0. 40 < ImgH / L \leq 3. \qquad ( 2 )$$

The inequality (2) defines the ratio between the maximum image height and the optical overall length of the optical system L0. Here, the maximum image height of the optical system L0 refers to a distance from a position on the image plane IP at which peripheral illumination is 10% to an optical axis when illumination is 100% at a position on the optical axis. In addition, the optical overall length L of the optical system L0 refers to a distance along the optical axis from the surface vertex of the object-side lens surface of a first lens G1, which is included in the front unit L1 and disposed closest to an object, to the image plane. When the ratio is less than a lower limit of the inequality (2), the overall length of the optical system L0 increases, which is not preferable since the size of the optical system increases. In addition, in one embodiment, the upper limit of the inequality (2) is set to 3.00, 2.95, 2.90, 2.85, 2.80, 2.75, 2.70, 2.65, 2.60, 2.55, or 2.50 to ensure the overall length of the optical system for favorably correcting various aberrations. Further, in yet another embodiment, the upper limit of the inequality (2) is set to 2.45, 2.40, 2.35, 2.30, 2.25, 2.20, 2.15, 2.10, 2.05, or 2.00.

When the focal length of the first lens G1, which is disposed closest in the optical system L0 to an object, is denoted by fG1, in one embodiment, the following inequality (3) is satisfied.

$$0.52 < fG 1 / f 1 \leq 2. \qquad ( 3 )$$

The inequality (3) defines the focal length of the front unit L1 and the focal length of the first lens G1, which is included in the front unit L1 and disposed closest to an object. When each of the focal lengths is less than a lower limit of the inequality (3), barrel distortion aberration is strongly generated, which is not preferable. In addition, in one embodiment, the upper limit of the inequality (3) is set to 2.00, 1.95, 1.90, 1.85, 1.80, 1.75, 1.70, 1.65, 1.60, 1.55, or 1.50 to favorably correct distortion aberration.

When the off-axis focal length of the front unit L1 in a meridional direction is denoted by fω1, in one embodiment, the following inequality (4) is satisfied.

$$- 3. < f ω 1 / \vert f 1 \vert < 0. 00 \qquad ( 4 )$$

The inequality (4) defines the ratio between the on-axis focal length and the off-axis focal length of the front unit L1. When the ratio is less than a lower limit of the inequality (4), the front unit L1 has weaker refractive power for off-axis rays than for paraxial rays and allows barrel distortion aberration and field curvature to be generated strongly, which is not preferable. When the ratio is more than an upper limit of the inequality (4), reducing the overall length of the optical system L0 is difficult, which is not preferable, since the off-axis focal length of the front unit L1 has positive refractive power.

When the focal length of a lens GR, which is included in the rear unit L2 and disposed closest to an image, is denoted by fGR and the focal length of the rear unit L2 is denoted by f2, in one embodiment, the following inequality (5) is satisfied.

$$- 6.00 < fGR / f 2 < - 2. \qquad ( 5 )$$

The inequality (5) defines a range of the focal length of the lens GR, which is disposed in the optical system L0 to be closest to an image. When the range is less than a lower limit of the inequality (5), the negative refractive power of the lens GR with respect to the rear unit L2 is excessively weak. As a result, the back focus of the optical system L0 increases and causes the overall length of the optical system L0 to increase, which is not preferable. When the range is more than an upper limit of the inequality (5), the negative refractive power of the lens GR with respect to the rear unit L2 is excessively strong. As a result, the back focus of the optical system L0 decreases and causes the image plane IP and the lens GR to be excessively close to each other, which is not preferable.

When the half angle of view of the optical system L0 is denoted by @, in one embodiment, the following inequality (6) is satisfied.

$$48. < ω < 70. \qquad ( 6 )$$

The inequality (6) defines a range of the half angle of view of the optical system L0. When the range is less than a lower limit of the inequality (6), distortion aberration and field curvature are overcorrected, which is not preferable. When the range is more than an upper limit of the inequality (6), barrel distortion aberration and field curvature are strongly generated, which is not preferable.

When the Abbe number of a material of the negative lens GN1, which is included in the rear unit L2 and disposed closest to an object, with respect to the d-line is denoted by vd, in one embodiment, the following inequality (7) is satisfied.

$$14. < v d < 40.0 \qquad ( 7 )$$

The inequality (7) defines a range of the Abbe number of the material of the negative lens GN1. When the Abbe number is less than a lower limit of the inequality (7), on-axis chromatic aberration is overcorrected, which is not preferable. When the Abbe number is more than an upper limit of the inequality (7), the on-axis chromatic aberration is not corrected sufficiently, which is not preferable.

In addition, when the refractive index of the material of the negative lens GN1 with respect to the d-line is denoted by nd, in one embodiment, the following inequality (8) is satisfied.

$$1. 50 < n d < 1.7 \qquad ( 8 )$$

The inequality (8) defines a range of the refractive index of the material of the negative lens GN1. When the range is less than a lower limit of the inequality (8), spherical aberration is not sufficiently corrected, which is not preferable. When the range is more than an upper limit of the inequality (8), the spherical aberration is overcorrected, which is not preferable.

In addition, in one embodiment, the numerical ranges in the inequalities (2) to (8) are set to be the ranges in the following inequalities (2a) to (8a), respectively.

$$0.41 < ImgH / L < 1.5 \qquad ( 2 a )$$

$$0.56 < fG 1 / f 1 \qquad ( 3 a )$$

$$- 2.95 < f ω 1 / \vert f 1 \vert < - 0.02 \qquad ( 4 a )$$

$$- 5.8 < fGR / f 2 < - 2.2 \qquad ( 5 a )$$

$$49. < ω < 68. \qquad ( 6 a )$$

$$2 0. < vd < 38. \qquad ( 7 a )$$

$$1. 52 < nd < 1.65 \qquad ( 8 a )$$

In addition, in yet another embodiment, the numerical ranges in the inequalities (2) to (8) are set to be the ranges in the following inequalities (2b) to (8b), respectively.

$$0. 42 < ImgH / L < 1.3 \qquad ( 2 b )$$

$$0.6 < fG 1 / f 1 \qquad ( 3 b )$$

$$- 2.9 \; 0 < f ω 1 / \vert f 1 \vert < - 0.05 \qquad ( 4 b )$$

$$- 5.5 \; 0 < fGR / f 2 < - 2.8 \qquad ( 5 b )$$

$$50. < ω < 65. \qquad ( 6 b )$$

$$25. 0 < vd < 35. \qquad ( 7 a )$$

$$1. 55 < nd < 1.63 \qquad ( 8 a )$$

Next, a configuration that is for the optical system L0 in each of the examples to satisfy will be described.

In one embodiment, the optical system L0 of each of the examples includes at least ten lenses. It is possible by allowing refractive power to be shared among the lenses to increase the sensitivity of each of the lenses.

In the optical system L0 of each of the examples, the front unit L1 includes at least three lenses. Consequently, it is possible to favorably correct the distortion aberration in the front unit L1 while ensuring the number of lenses so as to allow the optical system to have a wide angle.

In the optical system L0 of each of the examples, the front unit L1 includes a positive lens. Since the rear unit L2 as a whole has positive refractive power, a lens having positive refractive power is disposed on each of the object side and the image side of the aperture stop SP as a result of the positive lens disposed in the front unit L1. It is thus possible to favorably correct the field curvature and the distortion aberration.

In one embodiment, one of the object-side lens surface and the image-side lens surface of at least one lens included in the optical system L0 of each of the examples is an aspherical surface. In particular, using an aspherical surface as the lens surface of the lens G1, which is included in the front unit L1 and disposed closest to an object, is preferable since the incidence angle of an off-axis ray that enters the lens G1 is small, which is advantageous for correction of the distortion aberration and for ensuring of the peripheral illumination. Note that it is more preferable, to increase the effect described above, that both the object-side lens surface and the image-side lens surface of the lens G1 are aspherical surfaces.

In the optical system L0 of each of the examples, a positive lens, another positive lens, and a negative lens are disposed in the rear unit L2 in order from a position closest to an object. With the positive lenses being disposed near and on the image side of the aperture stop SP, it is possible to converge a ray that has entered the rear unit L2 and possible to decrease the distance from the aperture stop SP to the image plane.

The object-side lens surface of the lens GR disposed closest to an image among the lenses included in the optical system L0 of each of the examples includes a portion that is near the optical axis and convex on the object side and a peripheral portion that is concave on the object side. Similarly, the image-side lens surface of the lens GR includes a portion that is near the optical axis and concave on the image side and a peripheral portion that is convex on the image side. Consequently, it is possible to correct the astigmatic aberration at the peripheral portion while correcting the Petzval sum at the portion near the optical axis of the lens GR.

In addition, in one embodiment, using, as a lens included in the optical system L0, a lens that is made from a resin material (lens B) is preferable since an aspherical lens shape having an inflection point such as that described above can be achieved.

Next, detailed configurations of Examples 1 to 4 will be described. Note that, regarding the optical system L0 of each of the examples, description of the same configurations as those of the optical system L0 of Example 1 will be omitted, and differences from Example 1 will be mainly described.

### Examples 1 to 3

The optical system L0 of each of Examples 1 to 3 consists of, in order from the object side, the front unit L1 having negative refractive power, the aperture stop SP, and the rear unit L2 having positive refractive power. With the front unit L1 having the negative refractive power, the optical system L0 has a configuration of a so-called retrofocus type, and the principal point is thus arranged on the image side and makes it possible to downsize the optical system L0 in the radial direction while ensuring back focus.

In the optical system L0 of each of Examples 1 to 3, the front unit L1 consists of lenses G1 to G3, and the rear unit L2 consists of lenses G4 to G10. In addition, an optical filter FL is disposed on the image side of the rear unit L2.

In the optical system L0 of each of Examples 1 to 3, the object-side lens surface and the image-side lens surface of the lens G1, which is included in the front unit L1 and disposed closest to an object, each have an aspherical surface shape. Consequently, the incidence angle of an off-axis ray that enters the lens G1 is small, which is advantageous for correction of distortion aberration and for ensuring of peripheral illumination.

In the optical system L0 of each of Examples 1 to 3, a positive lens, another positive lens, and a negative lens are disposed in the rear unit L2 in order from a position closest to an object. Consequently, it is possible due to having positive refractive power at the portion near and on the image side of the aperture stop SP to converge a ray that has entered the rear unit L2 and to decrease the distance between the aperture stop SP and the image plane.

In the optical system L0 of each of the Examples 1 to 3, the front unit L1 includes a positive lens G3. Consequently, a lens having positive refractive power is disposed on each of the object side and the image side of the aperture stop SP, and it is thus possible to favorably correct the field curvature and the distortion aberration.

In the optical system L0 of each of Examples 1 to 3, the object-side lens surface of the lens GR, which is disposed closest to an image, in the rear unit L2 includes a portion that is near the optical axis and convex on the object side and a peripheral portion that is concave on the object side. Similarly, the image-side lens surface of the lens GR includes a portion that is near the optical axis and concave on the image side and a peripheral portion that is convex on the image side. Consequently, it is possible to correct the astigmatic aberration at the peripheral portion while correcting the Petzval sum at the portion near the optical axis of the lens GR. In addition, a lens GR1 disposed adjacent to the object side of the lens GR and the negative lens GN1, which is disposed closest to an object among the negative lens included in the rear unit L2, also each have a lens shape similar to the lens shape of the lens GR.

In the optical system L0 of each of Examples 1 to 3, the negative lens GN1, which is included in the rear unit L2 and disposed closest to an object, is a lens that is made from a resin material. Consequently, the formability of the negative lens GN1 is improved and makes it possible to form the negative lens GN1 to have an aspherical lens shape having an inflection point.

### Example 4

In the optical system L0 of Example 4, the front unit L1 consists of four lenses, which are lenses G1 to G4, and the rear unit L2 consists of seven lenses, which are lenses G5 to G11. In addition, an optical filter FL is disposed on the image side of the rear unit L2.

In the optical system L0 of Example 4, three negative lenses are disposed in the front unit L1 in order from a position closest to an object. To ensure sufficient back focus in the wide-angle optical system, strong negative refractive power is applied on the object side of the optical system. It is possible by allowing the negative refractive power to be shared among the three negative lenses to reduce refractive power per one negative lens. It is thus possible to suppress generation of barrel distortion aberration and field curvature.

Next, Numerical examples 1 to 4 corresponding to Examples 1 to 4, respectively, are presented below.

In surface data of each numerical example, r (mm) denotes the radius of curvature of each optical surface, and d (mm) denotes the distance along an optical axis between a k-th surface and a (k+1)th surface. Note that k is a surface number counted from the object side. In addition, nd denotes the refractive index of a material of each optical member with respect to the d-line, and vd denotes the Abbe number of the material of each optical member. Here, when nC, nd, and nF denote refractive indexes of the c-line (656.3 nm), the d-line (587.56 nm), and the F-line (486.1 nm), respectively, of the Fraunhofer line, the Abbe number vd is expressed by the following expression.

$$v d = ( n d - 1 ) / ( nF - n C )$$

Note that, in each of the numerical examples, the half angle of view (°) of the optical system L0 is indicated, and the maximum image height corresponding to the half angle of view is indicated as “image height”. Further, in each of the numerical examples, a focal length of each lens unit at the d-line is indicated as lens-unit data. Note that d, focal length (mm), F-number, and half angle of view (°) are values when the optical system L0 in each of the examples is focused at infinity. BF (back focus) denotes a value that is obtained by converting a distance along the optical axis from a rearmost lens surface (surface closest to an image) to a paraxial image plane into a value in air. The overall lens length is a length that is obtained by adding back focus to a distance along the optical axis from the object-side lens surface of the lens disposed closest to an object among the lenses included in the optical system L0 to the image-side lens surface of the lens disposed closest to an image.

In addition, the sign * is placed on the right side of each of the surface numbers of aspherical lens surfaces of each lens. When X denotes the amount of displacement from the surface vertex in the optical axis direction, h denotes the height from the optical axis in a direction perpendicular to the optical axis, R denotes paraxial radius of curvature, k denotes the conic constant, and A4, A6, A8, A10, A12, A14, A16, A18, and A20 each denote the aspherical surface coefficient of each order, the aspherical surface shape is expressed by the following expression.

$$X = ( {h}^{2} / R ) / [ 1 + {\{ 1 ( 1 + k ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14} + A 16 \times {h}^{16} + A 18 \times {h}^{18} + A 20 \times {h}^{20}$$

The “e±XX” in each aspherical surface coefficient means “×10±^{XX}”.

### Numerical Example 1

Unit in mm
Surface Data

| Surface | | | | | Effective |
|---|---|---|---|---|---|
| Number | r | d | nd | νd | Diameter |
| 1* | 4.859 | 0.62 | 1.54400 | 56.0 | 5.21 |
| 2* | 2.086 | 0.21 | 3.83 | | |
| 3* | 2.140 | 0.50 | 1.69800 | 16.3 | 3.39 |
| 4* | 1.505 | 0.45 | 2.65 | | |
| 5* | 1.979 | 0.37 | 1.62100 | 23.6 | 2.05 |
| 6* | 2.928 | (variable) | 1.61 | | |
| 7 | (aperture) | ∞ | 0.12 | 1.43 | |
| 8* | −5.227 | 0.37 | 1.59100 | 27.2 | 1.44 |
| 9* | −2.331 | −0.04 | 1.60 | | |
| 10* | −14.675 | 0.71 | 1.54400 | 56.0 | 1.72 |
| 11* | −1.644 | 0.12 | 2.00 | | |
| 12* | −5.650 | 0.37 | 1.59100 | 27.2 | 2.11 |
| 13* | 6.521 | 0.37 | 2.42 | | |
| 14* | −4.439 | 0.37 | 1.69800 | 16.3 | 2.51 |
| 15* | −5.673 | 0.12 | 3.19 | | |
| 16* | −15.042 | 0.77 | 1.54400 | 56.0 | 3.87 |
| 17* | −2.385 | 0.12 | 4.44 | | |
| 18* | 2.800 | 0.87 | 1.54400 | 56.0 | 5.27 |
| 19* | 2.959 | 0.25 | 5.83 | | |
| 20* | 9.650 | 0.71 | 1.70500 | 14.0 | 6.30 |
| 21* | 3.941 | 0.38 | 7.10 | | |
| 22 | ∞ | 0.26 | 1.51700 | 64.2 | 7.72 |
| 23 | ∞ | (variable) | 7.81 | | |
| Image Plane | ∞ | | | | |

Aspherical Surface Data
First Surface
K = 0.00000e+00, A4 = −6.22726e−03, A6 = 2.49307e−03, A8 = −3.64351e−04,
A10 = 3.52612e−05, A12 = −1.60799e−06
Second Surface
K = 0.00000e+00, A4 = −6.31637e−03, A6 = −7.54161e−03, A8 = 4.00579e−03,
A10 = −1.04685e−03
Third Surface
K = 0.00000e+00, A4 = 3.88578e−02, A6 = −2.24306e−02, A8 = 6.14943e−03,
A10 = −1.93389e−03, A12 = 1.03603e−04
Fourth Surface
K = 0.00000e+00, A4 = 4.75101e−02, A6 = −4.04733e−02, A8 = −9.32003e−03,
A10 = −1.56527e−03
Fifth Surface
K = 0.00000e+00, A4 = 6.04506e−02, A6 = 1.06399e−02
Sixth Surface
K = 0.00000e+00, A4 = 9.61786e−02, A6 = 2.13213e−01, A8 = −4.47519e−01,
A10 = 4.46135e−01
A18 = −5.15324e−01, A20 = 1.37029e−01
Eighth Surface
K = 0.00000e+00, A4 = −9.37315e−02, A6 = −1.20621e−01
Ninth Surface
K = 0.00000e+00, A4 = 1.21352e−01, A6 = −3.85874e−01, A8 = −7.05670e−01,
A10 = 6.83274e+00, A12 = −2.23937e+01, A14 = 4.22889e+01, A16 = −4.74471e+01
A18 = 2.95638e+01, A20 = −7.91667e+00
Tenth Surface
K = 0.00000e+00, A4 = 2.84988e−01, A6 = −5.32788e−01, A8 = 2.28548e−01,
A10 = 2.74332e+00, A12 = −1.07381e+01, A14 = 2.03426e+01, A16 = −2.15153e+01
A18 = 1.20411e+01, A20 = −2.76919e+00
Eleventh Surface
K = 0.00000e+00, A4 = −3.24436e−02, A6 = −5.91821e−04
Twelfth Surface
K = 0.00000e+00, A4 = −3.47386e−01, A6 = 1.67850e−01
Thirteenth Surface
K = 0.00000e+00, A4 = −2.73129e−01, A6 = −8.79136e−04, A8 = 4.79035e−01,
A10 = −1.38435e+00, A12 = 2.28912e+00, A14 = −2.33036e+00, A16 = 1.44741e+00
A18 = −5.04487e−01, A20 = 7.62655e−02
Fourteenth Surface
K = 8.11732e+00, A4 = −1.16111e−02, A6 = −9.04062e−02, A8 = 1.54999e−01,
A10 = −4.17454e−01, A12 = 7.33737e−01, A14 = −8.04871e−01, A16 = 5.33042e−01
A18 = −1.98497e−01, A20 = 3.21986e−02
Fifteenth Surface
K = −1.00000e+00, A4 = −2.98752e−02, A6 = 1.36617e−02, A8 = −2.70764e−02,
A10 = 3.50423e−02, A12 = −3.00282e−02, A14 = 1.50734e−02, A16 = −4.36035e−03
A18 = 7.19102e−04, A20 = −5.68105e−05
Sixteenth Surface
K = 0.00000e+00, A4 = 5.76356e−02, A6 = −1.45974e−02
Seventeenth Surface
K = 0.00000e+00, A4 = 6.65221e−02, A6 = 8.95717e−03, A8 = −6.67550e−03,
A10 = 7.80982e−04
Eighteenth Surface
K = 0.00000e+00, A4 = −5.00789e−02, A6 = 3.86987e−03, A8 = −3.64654e−04
Nineteenth Surface
K = 0.00000e+00, A4 = −4.49372e−02, A6 = 2.22702e−03, A8 = −1.30128e−04,
A10 = 4.81439e−05, A12 = −6.92656e−06
Twentieth Surface
K = 0.00000e+00, A4 = −1.12949e−02, A6 = −3.05329e−03, A8 = 1.35380e−03,
A10 = −1.91853e−04, A12 = 1.10320e−05, A14 = −2.75407e−07, A16 = 6.58006e−09
Twenty-first Surface
K = 0.00000e+00, A4 = −3.51306e−02, A6 = 5.10806e−03, A8 = −5.06655e−04,
A10 = 2.25555e−05, A12 = −2.41588e−07, A14 = −8.18507e−10, A16 = −6.12513e−10
Various Data

| | |
|---|---|
| Focal length | 3.05 |
| F-number | 2.21 |
| Half angle of view | 51.80 |
| Image height | 3.88 |
| Overall lens length | 9.00 |
| BF | 0.56 |

Lens-Unit Data

| Unit | Starting Surface | Focal Length |
|---|---|---|
| L1 | 1 | −7.27 |
| L2 | 7 | 2.52 |

Single Lens Data

| Lens | Starting Surface | Focal Length |
|---|---|---|
| G1 | 1 | −7.30 |
| G2 | 3 | −10.73 |
| G3 | 5 | 8.54 |
| G4 | 8 | 6.79 |
| G5 | 11 | 3.34 |
| G6 | 13 | −5.06 |
| G7 | 15 | −33.42 |
| G8 | 17 | 5.10 |
| G9 | 19 | 32.59 |
| G10 | 21 | −9.96 |

### Numerical Example 2

Unit in mm
Surface Data

| Surface | | | | | Effective |
|---|---|---|---|---|---|
| Number | r | d | nd | νd | Diameter |
| 1* | 7.603 | 0.50 | 1.54400 | 56.0 | 5.65 |
| 2* | 2.188 | 0.26 | 4.06 | | |
| 3* | 2.277 | 0.57 | 1.69800 | 16.3 | 3.61 |
| 4* | 1.580 | 0.51 | 2.80 | | |
| 5* | 1.919 | 0.39 | 1.62100 | 23.6 | 2.10 |
| 6* | 2.936 | (variable) | 1.62 | | |
| 7 | (aperture) | ∞ | 0.10 | 1.38 | |
| 8* | −5.004 | 0.34 | 1.59100 | 27.2 | 1.38 |
| 9* | −2.364 | −0.04 | 1.52 | | |
| 10* | −58.417 | 0.82 | 1.54400 | 56.0 | 1.68 |
| 11* | −1.567 | 0.10 | 2.03 | | |
| 12* | −6.235 | 0.33 | 1.59100 | 27.2 | 2.11 |
| 13* | 5.581 | 0.37 | 2.43 | | |
| 14* | −4.238 | 0.34 | 1.69800 | 16.3 | 2.51 |
| 15* | −6.006 | 0.12 | 3.22 | | |
| 16* | −12.367 | 0.72 | 1.54400 | 56.0 | 3.86 |
| 17* | −2.300 | 0.12 | 4.34 | | |
| 18* | 2.752 | 0.87 | 1.54400 | 56.0 | 5.10 |
| 19* | 2.968 | 0.24 | 5.83 | | |
| 20* | 8.650 | 0.71 | 1.70500 | 14.0 | 6.41 |
| 21* | 3.917 | 0.38 | 7.13 | | |
| 22 | ∞ | 0.26 | 1.51700 | 64.2 | 7.61 |
| 23 | ∞ | (variable) | 7.75 | | |
| Image Plane | ∞ | | | | |

Aspherical Surface Data
First Surface
K = 0.00000e+00, A4 = −2.54223e−03, A6 = 2.33757e−03, A8 = −3.84207e−04,
A10 = 3.50458e−05, A12 = −1.32461e−06
Second Surface
K = 0.00000e+00, A4 = 7.40521e−03, A6 = −1.41320e−02, A8 = 5.86577e−03,
A10 = −1.03139e−03
Third Surface
K = 0.00000e+00, A4 = 4.76308e−02, A6 = −2.67859e−02, A8 = 8.78811e−03,
A10 = −2.38026e−03, A12 = 1.84157e−04
Fourth Surface
K = 0.00000e+00, A4 = 4.32085e−02, A6 = −3.07918e−02, A8 = −9.48084e−03,
A10 = −6.03052e−05
Fifth Surface
K = 0.00000e+00, A4 = 2.86233e−02, A6 = 8.52926e−03
Sixth Surface
K = 0.00000e+00, A4 = 7.74792e−02, A6 = 1.75679e−01, A8 = −3.64574e−01,
A10 = 3.79370e−01
A18 = −5.15324e−01, A20 = 1.37029e−01
Eighth Surface
K = 0.00000e+00, A4 = −8.87681e−02, A6 = −1.18145e−01
Ninth Surface
K = 0.00000e+00, A4 = 1.15568e−01, A6 = −3.86521e−01, A8 = −6.98859e−01,
A10 = 6.69233e+00, A12 = −2.19911e+01, A14 = 4.18834e+01, A16 = −4.75786e+01
A18 = 3.01112e+01, A20 = −8.20593e+00
Tenth Surface
K = 0.00000e+00, A4 = 2.75007e−01, A6 = −5.19088e−01, A8 = 1.94907e−01,
A10 = 2.85683e+00, A12 = −1.09850e+01, A14 = 2.08839e+01, A16 = −2.24096e+01
A18 = 1.27730e+01, A20 = −2.98287e+00
Eleventh Surface
K = 0.00000e+00, A4 = −2.23791e−02, A6 = −1.40848e−03
Twelfth Surface
K = 0.00000e+00, A4 = −3.62312e−01, A6 = 1.56113e−01
Thirteenth Surface
K = 0.00000e+00, A4 = −2.91008e−01, A6 = 4.72921e−03, A8 = 4.75371e−01,
A10 = −1.37581e+00, A12 = 2.28965e+00, A14 = −2.34641e+00, A16 = 1.46350e+00
A18 = −5.11400e−01, A20 = 7.74838e−02
Fourteenth Surface
K = 6.24444e+00, A4 = −6.07468e−03, A6 = −9.27356e−02, A8 = 1.54356e−01,
A10 = −4.04410e−01, A12 = 7.11676e−01, A14 = −7.80211e−01, A16 = 5.15461e−01
A18 = −1.93139e−01, A20 = 3.16383e−02
Fifteenth Surface
K = −1.00000e+00, A4 = −3.26227e−02, A6 = 1.45332e−02, A8 = −2.15837e−02,
A10 = 3.18867e−02, A12 = −3.00215e−02, A14 = 1.50493e−02, A16 = −4.14077e−03
A18 = 6.42277e−04, A20 = −5.08179e−05
Sixteenth Surface
K = 0.00000e+00, A4 = 5.95171e−02, A6 = −1.53097e−02
Seventeenth Surface
K = 0.00000e+00, A4 = 6.83654e−02, A6 = 1.07515e−02, A8 = −7.32994e−03,
A10 = 8.46131e−04
Eighteenth Surface
K = 0.00000e+00, A4 = −5.61689e−02, A6 = 5.80887e−03, A8 = −5.52956e−04
Nineteenth Surface
K = 0.00000e+00, A4 = −4.68548e−02, A6 = 3.40289e−03, A8 = −2.48175e−04,
A10 = 3.88490e−05, A12 = −4.96182e−06
Twentieth Surface
K = 0.00000e+00, A4 = −1.15333e−02, A6 = −3.03950e−03, A8 = 1.49966e−03,
A10 = −2.38658e−04, A12 = 1.75214e−05, A14 = −6.47029e−07, A16 = 1.24837e−08
Twenty-first Surface
K = 0.00000e+00, A4 = −3.51270e−02, A6 = 5.29599e−03, A8 = −5.16142e−04,
A10 = 1.99812e−05, A12 = 3.46321e−08, A14 = −1.78986e−09, A16 = −1.05303e−09
Various Data

| | |
|---|---|
| Focal length | 2.69 |
| F-number | 2.21 |
| Half angle of view | 55.27 |
| Image height | 3.88 |
| Overall lens length | 8.83 |
| BF | 0.45 |

Lens-Unit Data

| Unit | Starting Surface | Focal Length |
|---|---|---|
| L1 | 1 | −6.30 |
| L2 | 7 | 2.40 |

Single Lens Data

| Lens | Starting Surface | Focal Length |
|---|---|---|
| G1 | 1 | −5.84 |
| G2 | 3 | −11.14 |
| G3 | 5 | 7.77 |
| G4 | 8 | 7.24 |
| G5 | 11 | 2.95 |
| G6 | 13 | −4.93 |
| G7 | 15 | −22.40 |
| G8 | 17 | 5.06 |
| G9 | 19 | 28.66 |
| G10 | 21 | −10.82 |

### Numerical Example 3

Unit in mm
Surface Data

| Surface | | | | | Effective |
|---|---|---|---|---|---|
| Number | r | d | nd | νd | Diameter |
| 1* | 4.052 | 0.50 | 1.54400 | 56.0 | 4.97 |
| 2* | 2.130 | 0.12 | 3.95 | | |
| 3* | 2.256 | 0.40 | 1.69800 | 16.3 | 3.64 |
| 4* | 1.715 | 0.73 | 3.03 | | |
| 5* | 1.915 | 0.33 | 1.62100 | 23.6 | 1.97 |
| 6* | 2.290 | (variable) | 1.54 | | |
| 7 | (aperture) | ∞ | 0.10 | 1.42 | |
| 8* | −8.985 | 0.32 | 1.59100 | 27.2 | 1.42 |
| 9* | −3.828 | 0.13 | 1.54 | | |
| 10* | 126.934 | 0.85 | 1.54400 | 56.0 | 1.61 |
| 11* | −1.576 | 0.10 | 2.05 | | |
| 12* | −13.008 | 0.30 | 1.59100 | 27.2 | 2.17 |
| 13* | 3.580 | 0.30 | 2.48 | | |
| 14* | −4.280 | 0.30 | 1.69800 | 16.3 | 2.55 |
| 15* | −5.779 | 0.24 | 3.10 | | |
| 16* | −17.744 | 0.63 | 1.54400 | 56.0 | 4.01 |
| 17* | −2.291 | 0.10 | 4.34 | | |
| 18* | 2.732 | 0.87 | 1.54400 | 56.0 | 4.99 |
| 19* | 3.042 | 0.35 | 5.93 | | |
| 20* | 14.123 | 0.71 | 1.70500 | 14.0 | 6.84 |
| 21* | 3.877 | 0.38 | 7.50 | | |
| 22 | ∞ | 0.26 | 1.51700 | 64.2 | 7.61 |
| 23 | ∞ | (variable) | 7.75 | | |
| Image Plane | ∞ | | | | |

Aspherical Surface Data
First Surface
K = 0.00000e+00, A4 = −3.07731e−03, A6 = 3.00737e−03, A8 = −8.47144e−04,
A10 = 1.21092e−04, A12 = −6.93945e−06
Second Surface
K = 0.00000e+00, A4 = 2.86153e−02, A6 = −3.02061e−02, A8 = 9.25596e−03,
A10 = −1.37869e−03
Third Surface
K = 0.00000e+00, A4 = 6.15659e−02, A6 = −4.70842e−02, A8 = 1.50910e−02,
A10 = −2.32884e−03, A12 = 2.32308e−05
Fourth Surface
K = 0.00000e+00, A4 = 3.86307e−02, A6 = −4.60362e−02, A8 = 1.68308e−02,
A10 = −4.98505e−03
Fifth Surface
K = 0.00000e+00, A4 = 3.66836e−02, A6 = 2.61744e−02
Sixth Surface
K = 0.00000e+00, A4 = 8.63360e−02, A6 = 1.36372e−01, A8 = −2.19196e−01,
A10 = 2.29418e−01
A18 = −5.15324e−01, A20 = 1.37029e−01
Eighth Surface
K = 0.00000e+00, A4 = −1.03223e−01, A6 = −9.83741e−02
Ninth Surface
K = 0.00000e+00, A4 = −3.64040e−02, A6 = −1.43447e−01, A8 = −5.71314e−01,
A10 = 5.77888e+00, A12 = −2.47397e+01, A14 = 6.16318e+01, A16 = −9.00846e+01
A18 = 7.18831e+01, A20 = −2.41209e+01
Tenth Surface
K = 0.00000e+00, A4 = 1.11675e−01, A6 = −1.51230e−01, A8 = −3.40553e−01,
A10 = 3.41133e+00, A12 = −1.18030e+01, A14 = 2.25319e+01, A16 = −2.45121e+01
A18 = 1.40973e+01, A20 = −3.29067e+00
Eleventh Surface
K = 0.00000e+00, A4 = 3.16674e−02, A6 = −3.34507e−02
Twelfth Surface
K = 0.00000e+00, A4 = −3.06293e−01, A6 = 1.14326e−01
Thirteenth Surface
K = 0.00000e+00, A4 = −2.82012e−01, A6 = −2.15392e−02, A8 = 4.70890e−01,
A10 = −1.36401e+00, A12 = 2.26373e+00, A14 = −2.28280e+00, A16 = 1.39120e+00
A18 = −4.73228e−01, A20 = 6.95500e−02
Fourteenth Surface
K = −6.52180e+00, A4 = 1.60212e−02, A6 = −1.14233e−01, A8 = 1.34753e−01,
A10 = −3.61854e−01, A12 = 6.51815e−01, A14 = −7.07864e−01, A16 = 4.64806e−01
A18 = −1.75866e−01, A20 = 2.96999e−02
Fifteenth Surface
K = −1.00000e+00, A4 = −2.27112e−02, A6 = 1.02657e−02, A8 = −2.01315e−02,
A10 = 3.22438e−02, A12 = −3.06026e−02, A14 = 1.42662e−02, A16 = −3.20216e−03
A18 = 3.04576e−04, A20 = −5.54668e−06
Sixteenth Surface
K = 0.00000e+00, A4 = 6.26857e−02, A6 = −1.40260e−02
Seventeenth Surface
K = 0.00000e+00, A4 = 6.95417e−02, A6 = 1.29310e−02, A8 = −8.04863e−03,
A10 = 9.39637e−04
Eighteenth Surface
K = 0.00000e+00, A4 = −5.92072e−02, A6 = 4.64173e−03, A8 = −3.64040e−04
Nineteenth Surface
K = 0.00000e+00, A4 = −3.98586e−02, A6 = 3.65251e−03, A8 = −4.07558e−04,
A10 = 3.33785e−05, A12 = −2.86780e−06
Twentieth Surface
K = 0.00000e+00, A4 = −4.90605e−03, A6 = −4.51089e−03, A8 = 1.75998e−03,
A10 = −2.96272e−04, A12 = 2.67864e−05, A14 = −1.26658e−06, A16 = 2.47217e−08
Twenty-first Surface
K = 0.00000e+00, A4 = −3.29180e−02, A6 = 4.26108e−03, A8 = −3.93460e−04,
A10 = 1.76042e−05, A12 = −6.00855e−08, A14 = −3.39119e−09, A16 = −9.90108e−10
Various Data

| | |
|---|---|
| Focal length | 3.02 |
| F-number | 2.21 |
| Half angle of view | 52.06 |
| Image height | 3.88 |
| Overall lens length | 8.70 |
| BF | 0.45 |

Lens-Unit Data

| Unit | Starting Surface | Focal Length |
|---|---|---|
| L1 | 1 | −8.21 |
| L2 | 7 | 2.53 |

Single Lens Data

| Lens | Starting Surface | Focal Length |
|---|---|---|
| G1 | 1 | −9.08 |
| G2 | 3 | −14.67 |
| G3 | 5 | 14.10 |
| G4 | 8 | 11.03 |
| G5 | 10 | 2.87 |
| G6 | 12 | −4.72 |
| G7 | 14 | −25.75 |
| G8 | 16 | 4.77 |
| G9 | 18 | 24.73 |
| G10 | 20 | −7.80 |

### Numerical Example 4

Unit in mm
Surface Data

| Surface | | | | | Effective |
|---|---|---|---|---|---|
| Number | r | d | nd | νd | Diameter |
| 1* | 5.000 | 0.50 | 1.54400 | 56.0 | 5.88 |
| 2* | 2.227 | 0.34 | 4.24 | | |
| 3* | 2.344 | 0.40 | 1.69800 | 16.3 | 3.76 |
| 4* | 1.793 | 0.47 | 3.29 | | |
| 5* | 6.487 | 0.30 | 1.54400 | 56.0 | 3.07 |
| 6* | 4.232 | 0.19 | 2.76 | | |
| 7* | 1.969 | 0.30 | 1.62100 | 23.6 | 2.09 |
| 8* | 2.592 | (variable) | 1.75 | | |
| 9 | (aperture) | ∞ | 0.10 | 1.46 | |
| 10* | −5.665 | 0.30 | 1.59100 | 27.2 | 1.35 |
| 11* | −2.538 | 0.08 | 1.47 | | |
| 12* | 89.117 | 0.83 | 1.54400 | 56.0 | 1.56 |
| 13* | −1.557 | 0.10 | 1.93 | | |
| 14* | −3.735 | 0.30 | 1.59100 | 27.2 | 1.97 |
| 15* | 6.169 | 0.34 | 2.34 | | |
| 16* | −5.072 | 0.35 | 1.69800 | 16.3 | 2.43 |
| 17* | −8.148 | 0.10 | 3.12 | | |
| 18* | 27.830 | 0.72 | 1.54400 | 56.0 | 4.01 |
| 19* | −2.347 | 0.16 | 4.39 | | |
| 20* | 2.820 | 0.87 | 1.54400 | 56.0 | 5.22 |
| 21* | 2.961 | 0.24 | 5.82 | | |
| 22* | 8.518 | 0.71 | 1.70500 | 14.0 | 6.28 |
| 23* | 4.126 | 0.38 | 7.13 | | |
| 24 | ∞ | 0.26 | 1.51700 | 64.2 | 7.32 |
| 25 | ∞ | (variable) | 7.43 | | |
| Image Plane | ∞ | | | | |

Aspherical Surface Data
First Surface
K = 0.00000e+00, A4 = −6.07893e−04, A6 = 1.32175e−03, A8 = −2.93328e−04,
A10 = 3.07045e−05, A12 = −1.25878e−06
Second Surface
K = 0.00000e+00, A4 = 3.03485e−02, A6 = −1.67125e−02, A8 = 6.33996e−03,
A10 = −1.07597e−03
Third Surface
K = 0.00000e+00, A4 = 9.16094e−02, A6 = −3.58801e−02, A8 = 1.03115e−02,
A10 = −2.84761e−03, A12 = 2.39186e−04
Fourth Surface
K = 0.00000e+00, A4 = 9.51787e−02, A6 = −2.90906e−02, A8 = −9.16503e−03,
A10 = 1.21401e−03
Fifth Surface
K = 0.00000e+00, A4 = 1.12544e−01, A6 = −2.08590e−02, A8 = 8.45431e−04,
A10 = −5.73030e−04
Sixth Surface
K = 0.00000e+00, A4 = 1.55899e−01, A6 = −5.98208e−02
Seventh Surface
K = 0.00000e+00, A4 = 6.97646e−02, A6 = −3.75828e−02
Eighth Surface
K = 0.00000e+00, A4 = 5.97916e−02, A6 = 2.65502e−01, A8 = −6.09114e−01,
A10 = 5.87441e−01
A18 = −5.15324e−01, A20 = 1.37029e−01
Tenth Surface
K = 0.00000e+00, A4 = −8.55150e−02, A6 = −1.28438e−01
Eleventh Surface
K = 0.00000e+00, A4 = 1.59565e−01, A6 = −6.60450e−01, A8 = 7.69393e−01,
A10 = −3.08663e−01, A12 = 8.56686e−02, A14 = −3.97626e+00, A16 = 1.40912e+01
A18 = −1.89261e+01, A20 = 9.22077e+00
Twelfth Surface
K = 0.00000e+00, A4 = 3.35567e−01, A6 = −6.23402e−01, A8 = 3.12741e−01,
A10 = 2.85469e+00, A12 = −1.11485e+01, A14 = 2.10627e+01, A16 = −2.22059e+01
A18 = 1.20228e+01, A20 = −2.44933e+00
Thirteenth Surface
K = 0.00000e+00, A4 = 1.44043e−02, A6 = −3.33594e−02
Fourteenth Surface
K = 0.00000e+00, A4 = −4.07482e−01, A6 = 1.58953e−01
Fifteenth Surface
K = 0.00000e+00, A4 = −3.34168e−01, A6 = 6.35319e−03, A8 = 5.01334e−01,
A10 = −1.43512e+00, A12 = 2.41307e+00, A14 = −2.48412e+00, A16 = 1.54198e+00
A18 = −5.33067e−01, A20 = 7.98230e−02
Sixteenth Surface
K = −1.26320e+01, A4 = 1.85302e−02, A6 = −1.69465e−01, A8 = 1.85576e−01,
A10 = −3.88721e−01, A12 = 6.94163e−01, A14 = −7.92491e−01, A16 = 5.32772e−01
A18 = −1.98749e−01, A20 = 3.05655e−02
Seventeenth Surface
K = −1.00000e+00, A4 = −1.50198e−02, A6 = −5.99313e−03, A8 = −1.78373e−02,
A10 = 3.19572e−02, A12 = −3.04820e−02, A14 = 1.52540e−02, A16 = −4.63191e−03
A18 = 9.11564e−04, A20 = −9.37171e−05
Eighteenth Surface
K = 0.00000e+00, A4 = 4.50798e−02, A6 = −1.13848e−02
Nineteenth Surface
K = 0.00000e+00, A4 = 6.75442e−02, A6 = 1.15663e−02, A8 = −7.29456e−03,
A10 = 8.55124e−04
Twentieth Surface
K = 0.00000e+00, A4 = −6.04143e−02, A6 −7.15022e−03, A8 = −5.74141e−04
Twenty-first Surface
K = 0.00000e+00, A4 = −5.00251e−02, A6 = 4.21282e−03, A8 = −3.31094e−04,
A10 = 5.54193e−05, A12 = −6.88983e−06
Twenty-two Surface
K = 0.00000e+00, A4 = −1.08354e−02, A6 = −3.65405e−03, A8 = 1.55345e−03,
A10 = −2.31254e−04, A12 = 1.62608e−05, A14 = −5.90919e−07 A16 = 1.15953e−08
Twenty-three Surface
K = 0.00000e+00, A4 = −3.19763e−02, A6 = 4.61814e−03, A8 = −4.53528e−04,
A10 = 1.92003e−05, A12 = 1.72738e−08, A14 = 4.58410e−10, A16 = −1.34101e−09
Various Data

| | |
|---|---|
| Focal length | 2.58 |
| F-number | 2.21 |
| Half angle of view | 56.35 |
| Image height | 3.88 |
| Overall lens length | 9.00 |
| BF | 0.45 |

Lens-Unit Data

| Unit | Starting Surface | Focal Length |
|---|---|---|
| L1 | 1 | −6.13 |
| L2 | 9 | 2.36 |

Single Lens Data

| Lens | Starting Surface | Focal Length |
|---|---|---|
| G1 | 1 | −7.88 |
| G2 | 3 | −15.55 |
| G3 | 5 | −23.47 |
| G4 | 7 | 11.15 |
| G5 | 10 | 7.51 |
| G6 | 12 | 2.82 |
| G7 | 14 | −3.89 |
| G8 | 16 | −20.19 |
| G9 | 18 | 4.01 |
| G10 | 20 | 34.20 |
| G11 | 22 | −12.16 |

Numerical values in the inequalities (1) to (8) in Examples are indicated in Table 1.

TABLE 1

| | EXAM- | EXAM- | EXAM- | EXAM- |
|---|---|---|---|---|
| | PLE 1 | PLE 2 | PLE 3 | PLE 4 |
| f | 3.05 | 2.69 | 3.02 | 2.58 |
| f1 | −7.27 | −6.3 | −8.21 | −6.13 |
| f2 | 2.52 | 2.40 | 2.53 | 2.36 |
| fG1 | −7.30 | −5.84 | −9.08 | −7.88 |
| fω1 | −20.57 | −18.08 | −12.40 | −16.86 |
| fGR | −9.96 | −10.82 | −7.8 | −12.16 |
| ImgH | 3.88 | 3.88 | 3.88 | 3.88 |
| L | 9.00 | 8.83 | 8.70 | 9.00 |
| ω | 51.79 | 55.27 | 52.06 | 56.35 |
| νd | 27.20 | 27.20 | 27.20 | 27.20 |
| n | 1.59 | 1.59 | 1.59 | 1.59 |
| (1) f1/f | −2.38 | −2.34 | −2.72 | −2.38 |
| (2) ImgH/L | 0.43 | 0.44 | 0.45 | 0.43 |
| (3) fω1/f1 | 1.00 | 0.93 | 1.11 | 1.29 |
| (4) fω1/\|f1\| | −2.83 | −2.87 | −1.51 | −2.75 |
| (5) fGR/f2 | −3.95 | −4.51 | −3.09 | −5.15 |
| (6) ω | 51.79 | 55.27 | 52.06 | 56.35 |
| (7) νd | 27.20 | 27.20 | 27.20 | 27.20 |
| (8) n | 1.59 | 1.59 | 1.59 | 1.59 |

### Imaging Device

Next, an imaging device in which the optical system L0 in each of the examples is used as an imaging optical system will be described.

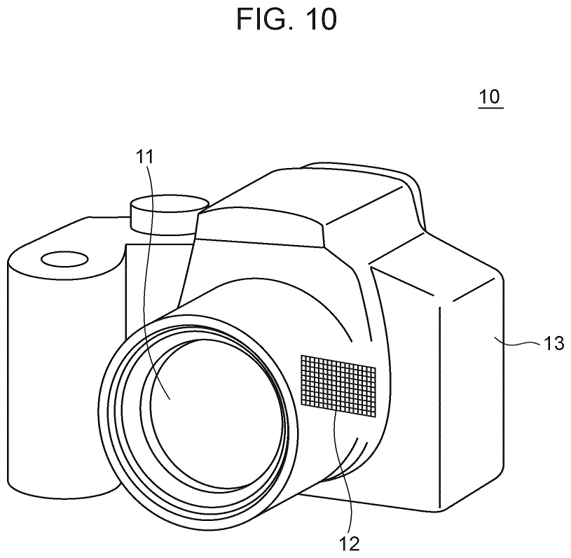

FIG. 10 is a schematic view of an imaging device 10 that includes the optical system L0 in each of the examples. The imaging device 10 includes a camera body 13, an optical system 11, which is the same as one of the optical systems L0 described in Examples 1 to 4 described above, and a light-receiving element 12 that photoelectrically converts an image formed by the optical system 11.

Note that, as the light-receiving element 12, an imaging element such as a CCD or CMOS sensor is usable. At this time, quality of an output image can be improved by correcting various aberrations such as distortion aberration and chromatic aberration of an image, which is acquired by the light-receiving element 12, by using an electrical method, for example.

Note that, not only to the digital still camera illustrated in FIG. 10, the optical system L0 of each of the examples is also applicable to various types of optical equipment such as a digital video camera and a silver-halide film camera. In addition, the camera may be of a lens integrated type or may be of a lens interchangeable type.

### Lens Device

Next, a lens device in which the optical system L0 of each of the examples is used will be described.

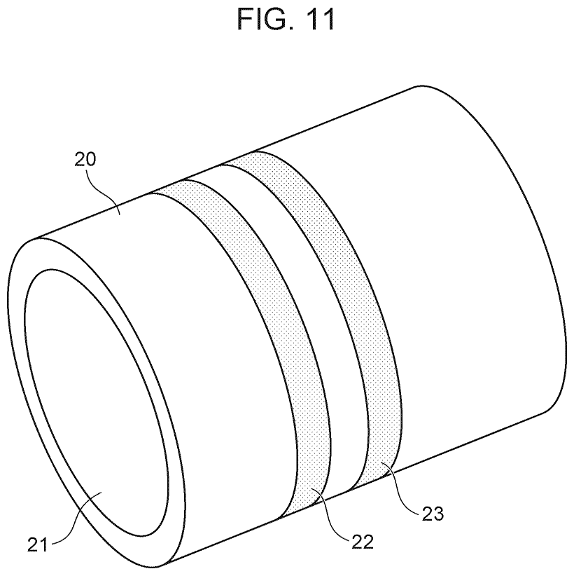

FIG. 11 is a schematic external view of a lens device 20 that includes the optical system L0 of each of the examples. The lens device 20 is a so-called interchangeable lens that is to be detachably mounted on a camera body, which is not illustrated.

The lens device 20 includes an imaging optical system 21 consisting of one of the optical systems described in Examples 1 to 4. In addition, the lens device 20 includes a focus operation unit 22 and an operation unit 23 that is configured to change an imaging mode.

The focus operation unit 22 is operated by a user to mechanically or electrically change the arrangement of the imaging optical system 21 so that the focal position can be changed.

In addition, the operation unit 23 may be operated by a user to change, for a purpose other than focusing, the arrangement of a lens unit of the imaging optical system 21. For example, in response to an operation of the operation unit 23, the arrangement of the lens unit of the imaging optical system 21 may be mechanically or electrically changed to change the aberration of the imaging optical system 21. At this time, in one embodiment, it is preferable that a focusing position does not change substantially.

While an exemplary embodiment and examples of the disclosure in the specification have been described above, the disclosure is not limited to these embodiment and examples, and various combinations, variations, and changes can be made within the scope of the gist thereof.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-195050, filed Nov. 7, 2024, which is hereby incorporated by reference herein in its entirety.

What is claimed is:

1. A system comprising, in order from an object side to an image side:
a front unit having negative refractive power;
an aperture stop;
a rear unit having positive refractive power; and
at least ten lenses,
wherein the rear unit includes an aspherical lens A having an inflection point, and
wherein the following inequalities are satisfied:
$$- 2.98 < f 1 / f < 0 \text{.00}$$
$$0. 40 < ImgH / L$$
where f denotes a focal length of the system as a whole, f1 denotes a focal length of the front unit, ImgH denotes a maximum image height of the system, and L denotes an overall length of the system.

2. The system according to claim 1,
wherein the following inequality is satisfied:
$$0.52 < fG 1 / f 1$$
where fG1 denotes a focal length of a lens G1 disposed closest to an object among lenses included in the front unit.

3. The system according to claim 1,
wherein the front unit includes a positive lens.

4. The system according to claim 1,
wherein, in the rear unit, a positive lens, another positive lens, and a negative lens are disposed in order from a position closest to an object toward an image.

5. The system according to claim 1,
wherein the following inequality is satisfied:
$$- 3. < f ω 1 / \vert fl \vert < 0. 00$$
where fω1 denotes an off-axis focal length of the front unit in a meridional direction.

6. The system according to claim 1,
wherein the following inequality is satisfied:
$$- 6.00 < fGR / f 2 < - 2.$$
where fGR denotes a focal length of a lens GR included in the rear unit and disposed closest to an image, and f2 denotes a focal length of the rear unit.

7. The system according to claim 1,
wherein the following inequality is satisfied:
$$48. < ω < 70.$$
where ω [°] denotes a half angle of view corresponding to a maximum image height of the system.

8. The system according to claim 1,
wherein the following inequality is satisfied:
$$14. < v d < 40.0$$
where vd denotes an Abbe number of a material of a negative lens GN1 disposed closest to an object among negative lenses included in the rear unit.

9. The system according to claim 8,
wherein the following inequality is satisfied:
$$1.5 < n d < 1.7$$
where nd denotes a refractive index of a material of the negative lens GN1 with respect to a d-line.

10. The system according to claim 1,
wherein the following inequality is satisfied:
$$0. 40 < ImgH / L < 3. .$$

11. The system according to claim 1,
wherein the following inequality is satisfied:
$$0.52 < fG 1 / f 1 < 2.$$
where fG1 denotes a focal length of a lens G1 disposed closest to an object among lenses included in the front unit.

12. The system according to claim 1,
wherein the system includes a lens B that is made from a resin material, and
wherein at least one of an object-side lens surface and an image-side lens surface of the lens B is an aspherical surface.

13. The system according to claim 1,
wherein an object-side lens surface of a lens GR included in the rear unit and disposed closest to an image includes a portion that is near an axis and convex on an object side and a peripheral portion that is concave on an object side, and
wherein an image-side lens surface of the lens GR includes a portion that is near the axis and concave on an image side and a peripheral portion that is convex on an image side.

14. The system according to claim 1,
wherein an object-side lens surface of a lens GR1 includes a portion that is near an axis and convex on an object side and a peripheral portion that is concave on an object side, the lens GR 1 being disposed on an object side of and adjacent to a lens included in the rear unit and disposed closest to an image, and
wherein an image-side lens surface of the lens GR1 includes a portion that is near the axis and concave on an image side and a peripheral portion that is convex on an image side.

15. The system according to claim 1,
wherein an object-side lens surface of a negative lens GN1 disposed closest to an object among negative lenses included in the rear unit includes a portion that is near an axis and convex on an object side and a peripheral portion that is concave on an object side, and
wherein an image-side lens surface of the negative lens GN1 includes a portion that is near the axis and concave on an image side and a peripheral portion that is convex on an image side.

16. The system according to claim 1,
wherein the front unit consists of three lenses, and the rear unit consists of seven lenses.

17. The system according to claim 1,
wherein the front unit consists of four lenses, and the rear unit consists of seven lenses.

18. An imaging device comprising:
a system; and
an imaging element that receives an image formed by the system,
wherein the system comprising, in order from an object side to an image side:
a front unit having negative refractive power;
an aperture stop;
a rear unit having positive refractive power; and
at least ten lenses,
wherein the rear unit includes an aspherical lens having an inflection point, and
wherein the following inequalities are satisfied:
$$- 2.98 < f 1 / f < 0 \text{.00}$$
$$0. 40 < ImgH / L$$
where f denotes a focal length of the system as a whole, f1 denotes a focal length of the front unit, ImgH denotes a maximum image height of the system, and L denotes an overall length of the system.

19. A lens device comprising:
a system; and
an operation unit configured to be operated by a user,
wherein the system comprising, in order from an object side to an image side:
a front unit having negative refractive power;
an aperture stop;
a rear unit having positive refractive power; and
at least ten lenses,
wherein the rear unit includes an aspherical lens having an inflection point, and
wherein the following inequalities are satisfied:
$$- 2.98 < f 1 / f < 0 \text{.00}$$
$$0. 40 < ImgH / L .$$
where f denotes a focal length of the system as a whole, f1 denotes a focal length of the front unit, ImgH denotes a maximum image height of the system, and L denotes an overall length of the system.
